(19) United States
(12) Patent Application Publication
(10) Pub. No.: US 2008/0165382 A1
(43) Pub. Date: Jul. 10, 2008

(54) SYSTEMS AND METHODS FOR VARIABLE FORM PRINTING USING REMOVABLE STORAGE

(75) Inventor: Andrew Rodney Ferlitsch, Camas, WA (US)

Correspondence Address: MADSON & AUSTIN, 15 WEST SOUTH TEMPLE, SUITE 900, SALT LAKE CITY, UT, 84101, US

(73) Assignee: Sharp Laboratories of America, Inc., Camas, WA (US)

(21) Appl. No.: 11/620,555

(22) Filed: Jan. 5, 2007

(51) Int. Cl. G06F 15/00

(52) U.S. Cl. 358/1.15

(57) ABSTRACT

A method for printing using removable storage is described. An imaging job is initiated, wherein the imaging job comprises a fixed portion and a variable portion. The fixed portion is provided to an imaging device. The variable portion is provided to the imaging device. One of the fixed portion or the variable portion is communicated from a removable storage device to the imaging device. The fixed portion and the variable portion are merged into a combined document. The combined document is output.

### TECHNICAL FIELD

The present invention relates generally to computers and computer-related technology. More specifically, the present invention relates to systems and methods for variable form printing using removable storage.

### BACKGROUND

Computer and communication technologies continue to advance at a rapid pace. Indeed, computer and communication technologies are involved in many aspects of a person's day. For example, many devices being used today by consumers have a small computer incorporated within the device. These small computers come in varying sizes and degrees of sophistication. These small computers may vary in sophistication from one microcontroller to a fully-functional complete computer system. For example, small computers may be a one-chip computer, such as a microcontroller, a one-board type of computer, such as a controller, a typical desktop computer, such as an IBM-PC compatible, etc.

Printers are used with computers to print various kinds of items including letters, documents, pictures, etc. Many different kinds of printers are commercially available. Ink jet printers and laser printers are fairly common among computer users. Ink jet printers propel droplets of ink directly onto the paper. Laser printers use a laser beam to print.

Printers are a type of imaging device. Imaging devices include, but are not limited to, physical printers, multi-functional peripherals, a printer pool, a printer cluster, a fax machine, a plotter, a scanner, a logical device, an electronic whiteboard, a tablet PC, a computer monitor, a file, etc.

Different kinds of computer software facilitate the use of imaging devices. The computer or computing device that will be used to print the materials typically has one or more pieces of software running on the computer that enable it to send the necessary information to the printer to enable printing of the materials. If the computer or computing device is on a computer network there may be one or more pieces of software running on one or more computers on the computer network that facilitate printing.

Information or data that is to be sent to an imaging device may come from a variety of devices, including, but not limited to, removable storage devices. Removable storage devices for computing devices enables computer users to easily take electronic data from one place to another. Benefits may be realized by providing systems and methods for printing using removable storage.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is a block diagram illustrating an embodiment of a system for variable form printing using removable storage;

FIG. 2 is a flow diagram of an embodiment of a method for variable form printing using removable storage;

FIG. 3 is a block diagram illustrating another embodiment of a system for variable form printing using removable storage;

FIG. 4 is a block diagram illustrating another embodiment of a system for variable form printing using removable storage;

FIG. 5 is a block diagram illustrating an embodiment of a system for variable form printing using removable storage where at least one fixed portion of the variable data printing job is on removable media, and at least one variable portion is from another source;

FIG. 6 is a block diagram illustrating another embodiment of a system for variable form printing using removable storage where the user initiates the variable data printing job from a remote interface (e.g., host), such as a print job;

FIG. 7 is a block diagram illustrating another embodiment of a system for variable form printing using removable storage where at least one variable portion of the variable data printing job is on removable media, and at least one fixed portion is from another source;

FIG. 8 is a block diagram illustrating another embodiment of a system for variable form printing using removable storage where at least one variable portion of the variable data printing job is on removable media, and at least one fixed portion is from another source;

FIG. 9 is a block diagram illustrating the major hardware components typically utilized with embodiments herein; and

FIG. 10 is a network block diagram illustrating one possible environment in which the present systems and methods may be implemented.

### DETAILED DESCRIPTION

A method for printing using removable storage is described. An imaging job is initiated, wherein the imaging job comprises a fixed portion and a variable portion. The fixed portion is provided to an imaging device. The variable portion is provided to the imaging device. One of the fixed portion or the variable portion is communicated from a removable storage device to the imaging device. The fixed portion and the variable portion are merged into a combined document. The combined document is output.

Authentication may be performed in order to access one of the fixed portion or the variable portion. The fixed portion may be fixed data including, but not limited to, form, layout, imposition rules, rendering settings, watermark, fonts, and overlay. An interface may be provided for selection of the fixed portion or the variable portion.

The removable storage device may comprise a Universal Serial Bus (USB) memory stick. The removable storage device may be inserted into a local port connection on the imaging device. In one configuration, the imaging device may be a multi-functional peripheral (MFP).

Outputting may comprise providing the combined document to an output engine that may include any of the following: a copier, a fax, a file, and a send to destination.

In an embodiment, data may be cleared from memory of the imaging device.

An imaging device that is configured for printing using removable storage is also described. The imaging device includes a processor and memory in electronic communication with the processor. Instructions are stored in the memory and are executable. An initiation for an imaging job is received, wherein the imaging job comprises a fixed portion and a variable portion. The fixed portion is accessed by the imaging device. The variable portion is accessed by the imaging device. One of the fixed portion or the variable portion is communicated from a removable storage device to the imaging device. The fixed portion and the variable portion are merged into a combined document. The combined document is output.

A computer-readable medium comprising executable instructions for printing using removable storage is also described. An imaging job is initiated, wherein the imaging job comprises a fixed portion and a variable portion. The fixed portion is provided to an imaging device. The variable portion is provided to the imaging device. One of the fixed portion or the variable portion is communicated from a removable storage device to the imaging device. The fixed portion and the variable portion are merged into a combined document. The combined document is output.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not necessarily all) embodiments of the disclosed invention(s)”, unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on”does not mean “based only on,” unless expressly specified otherwise. In other words, the phrase “based on” describes both ”based only on” and “based at least on.”

Removable storage for computing devices enables computer users to take electronic data from one place to another without requiring a more bulky computing device. There are many different kinds of removable storage media that can be used to store electronic data or information. One type of removable storage media is the USB (Universal Serial Bus) flash drive, sometimes referred to as a thumb drive or a memory stick. Most computers have USB ports, which allow memory sticks/USB flash drives to simply be plugged into the USB ports for access to the data that is stored on the memory stick/USB flash drive. Because USB ports and/or memory sticks/USB flash drives are so common, there are features that would be desirable that could be used in conjunction with a USB port and/or memory stick, such as variable data printing, where variable data is on the memory stick, or fixed data (form) is on the memory stick. More specifically, a user can obtain an added level of security to either the form data or variable print data, by placing the data only on the USB memory stick; where the form or variable data would only be accessible from the USB memory stick, and the MFP (multi-functional printer/product/peripheral) would destroy any temporary copy in the MFP's memory/storage after completion of the operation.

One method of variable data printing provides an output that has a fixed data layout and a variable data input. The fixed data layout is constructed from an imposition system, which is then rendered into a printable format (e.g., PostScript). The variable data is then separately rendered, and the fixed and variable rendered portions are then merged into a single composed printable document. The composed printable document is then sent to the printer for printing. Additionally, the rendered fixed portion may be saved in a database for reuse, but this method still has several limitations. The operation requires the composition process to occur on the host. It does not disclose using the storage capability of the MFP. It does not disclose using removable storage for either the fixed or variable portion. This method does not disclose any means of authentication/access control to the stored fixed or variable data. Finally, this method only supports print jobs.

In another method of variable data printing, the fixed portion is pre-downloaded to the MFP (e.g., form), where it is rendered and stored in a repository within the MFP (e.g., filing storage). The stored rendered fixed portion can then be repeatedly reused by downloading a print job that contains the variable data and reference to the fixed portion to merge with. The MFP then renders the variable data, retrieves the stored rendered fixed data and merges them into a composed rendered document for outputting. This method still has limitations. It does not disclose using removable storage for either the fixed or variable portion. It does not disclose any means of authentication/access control to the stored fixed or variable data. This method also only supports print jobs, and it discloses only storing the fixed data.

In a further method of variable printing, the fixed portion is rendered into a printable format on a host and downloaded as a print job to the MFP. During the Raster Image Process (RIP), the variable data portion is retrieved from a database that is accessible from the MFP, where the variable data portion is then rendered and merged with the fixed portion in the RIP process. But this method still has limitations in that it does not disclose using removable storage for either the fixed or variable portion, and it does not disclose any means of authentication/access control to the stored fixed or variable data. Furthermore, this method only supports print jobs and discloses only storing the variable data.

The present systems and methods may provide benefits for variable form printing using removable storage. For example, the present system may facilitate the use of removable media for the fixed or variable portion. Furthermore, it may allow the input to be entered as a walkup (copy) or remote (print) job. Authenticated access control to the removable media may also be provided.

Additionally, the systems and methods herein may provide an additional layer of security to the user's personal form or variable data, where the user's form or variable data is only accessible from the USB memory stick, and/or where the MFP destroys any temporary copy in the MFP's memory/storage after completion of the operation.

The exemplary operating environment includes multi-functional printers/products/peripherals (MFPs). Document generating devices and MFPs will be referred hereinafter as a device. In one embodiment, a device may include a copier, printer, scanner, facsimile machine (fax), media card reader, hard disk, etc. An MFP may take either hardcopy or softcopy input and produce a hardcopy (e.g., copy/print) or softcopy (e.g., scan/fax) output. The MFP additionally has one or more ports for accessing softcopy data from a removable media (e.g., USB memory stick). The MFP may additionally have internal filing storage.

With the present systems and methods, a user may perform a variable printing job as either a walkup (copy) or remote (print) job, and where either the fixed or variable portion of the job is stored on removable media (e.g., USB memory stick). In one embodiment, the fixed portion is stored on the removable media, which is communicatively connected to the MFP (e.g., USB port). A user may then initiate a variable printing job as either a walkup or remote job. In the former case, the user can use the MFP's front panel to browse/select the fixed portion from the removable media and enter/specify the location of the variable data. In the later case, a process on a host is communicatively coupled to the MFP. From the host, the user is able to access a remote interface to the MFP (e.g., web page), from which the user may browse/select the fixed portion from the removable media and enter/specify the location of the variable data. The variable data is then downloaded to the MFP, where the MFP renders the variable data and merges it with the fixed portion. In either case, the MFP may optionally require authentication to access fixed data from the removable storage. Additionally, the files on the removable storage may also have access privilege settings (e.g., owner, read/write access). In this case, the MFP can additionally require the authenticated user match the owner of the files to be accessed on the removable storage. Other access rights may be utilized.

In a second embodiment, the variable portion is stored on the removable media, which is communicatively connected to the MFP. A user may then initiate a variable printing job as either a walkup or remote job. In the former case, the user can use the MFP's front panel to browse/select the variable portion from the removable media and enter/specify the location of the fixed data (e.g., scanner). In the later case, a process on a host is communicatively coupled to the MFP. From the host, the user is able to access a remote interface to the MFP, from which the user may browse/select the variable portion from the removable media and enter/specify the location of the fixed data. The fixed data is then downloaded to the MFP, where the MFP renders the fixed data and merges it with the variable portion.

The MFP may optionally require authentication to access fixed data from the removable storage. Additionally, the files on the removable storage may also have access privilege settings (e.g., owner, read/write access). In this case, the MFP can additionally require the authenticated user match the owner of the files to be accessed on the removable storage. Other access rights may be used.

The system may also support additional functionality. Authentication/access control/decryption of the data stored on the removable media may be supported. The system may also support external rendering services, such as converting non-native format data on the removable media to a format native to the MFP.

When the MFP accesses either the fixed/variable data from the removable storage, the MFP only maintains a temporary copy of the data in either memory or other storage. The memory/storage copy may not be accessible by any other operation other than the operation that requested the fixed/variable data. When the requested rendering operation is completed, the MFP then deletes the temporary copy and may additionally obscure any residual trace from memory or other storage, such as by techniques disclosed in U.S. Patent Application Publication No. 2005/0068578 for “Random Bit Mask By-Product File Disk Obscuring,” which is incorporated herein by reference.

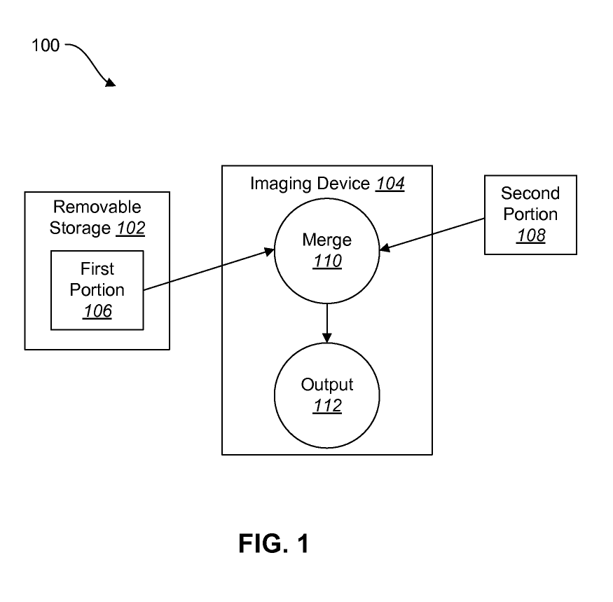

FIG. 1 is a block diagram illustrating an embodiment 100 for variable form printing using removable storage 102. An imaging job is processed by an imaging device 104. The imaging job includes two parts: a first portion 106 and a second portion 108. One portion is a fixed portion, while the other is a variable portion, which will be more fully discussed below. The first portion 106 and the second portion 108 are merged by a merging process 110 on the imaging device 104. The merging process 110 is a broadly defined process that somehow combines the first portion 106 with the second portion 108 so that the combined document may be provided to an output engine 112. The output engine 112 may be any of a variety of output engines 112 associated with different kinds of imaging devices 104.

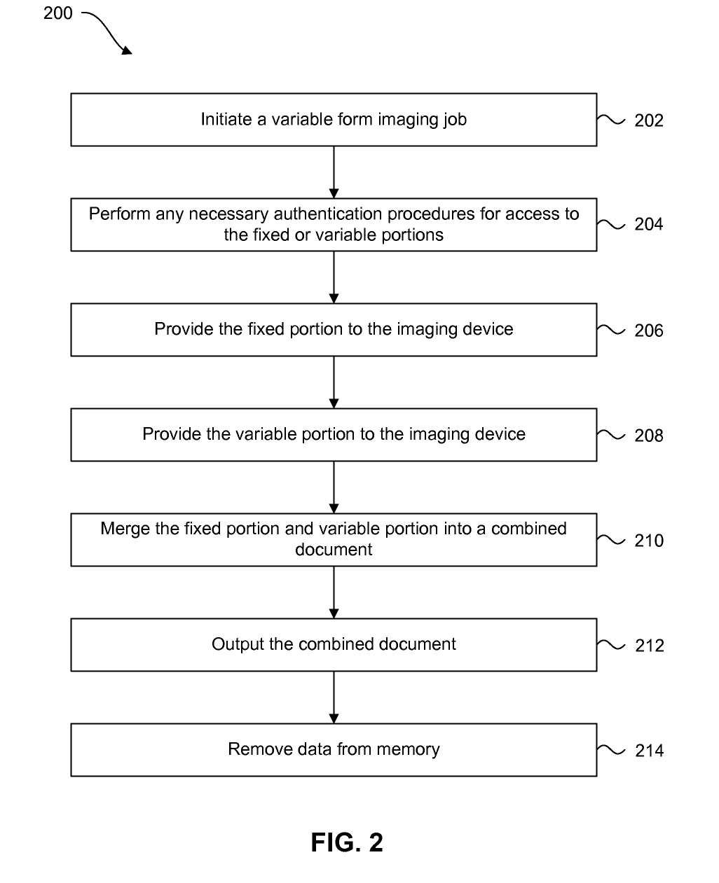

FIG. 2 is a flow diagram of an embodiment 200 of a method for variable form printing using removable storage 102. A variable form imaging job is initiated 202. The variable form imaging job may either be initiated as a walkup (copy) or a remote (print) job. The variable imaging job comprises a fixed portion and a variable portion. One of the fixed portion or variable portion is stored on removable storage 102.

If any access rights are being utilized or are required, any necessary authentication procedures for access to the fixed or variable portions are performed 204. The fixed portion is provided 206 to the imaging device 104. The variable portion is provided 208 to the imaging device 104. The imaging device 104 merges 210 the fixed portion and variable portion into a combined document. The combined document is then output 212 in a form that includes both the fixed portion and the variable portion. If necessary, the imaging device removes 214 any copies of data from memory.

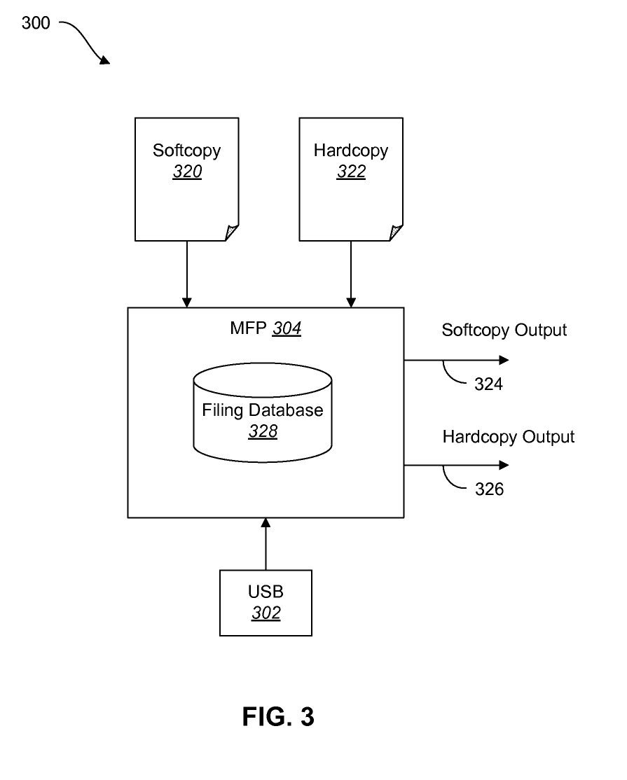

FIG. 3 is a block diagram illustrating another embodiment 300 for variable form printing using removable storage 302. The operating environment 300 shown in FIG. 3 includes a network (not shown), locally or remotely connected multi-functional peripheral devices 304 (MFP) with at least copy and/or print capability and filing capability. The MFP 304 may support other imaging capabilities such as scan, format conversion, publishing device and fax. The MFP 304 also has input and output access to at least one form of removable storage, such as a USB memory stick 302, a floppy, CD, DVD, or removable hard-drive. Additionally, the MFP 304 supports a variable data printing capability, where an output job has at least one part or portion that is fixed and one part or portion that is variable. Different kinds of input may be provided to the MFP 304, such as softcopy input 320 and hardcopy input 322. Different kinds of output may be provided by the MFP 304, such as softcopy output 324 and hardcopy output 326. The MFP 304 may also include internal storage 328, which may include, by way of example, a file system, a database, a filing database, etc.

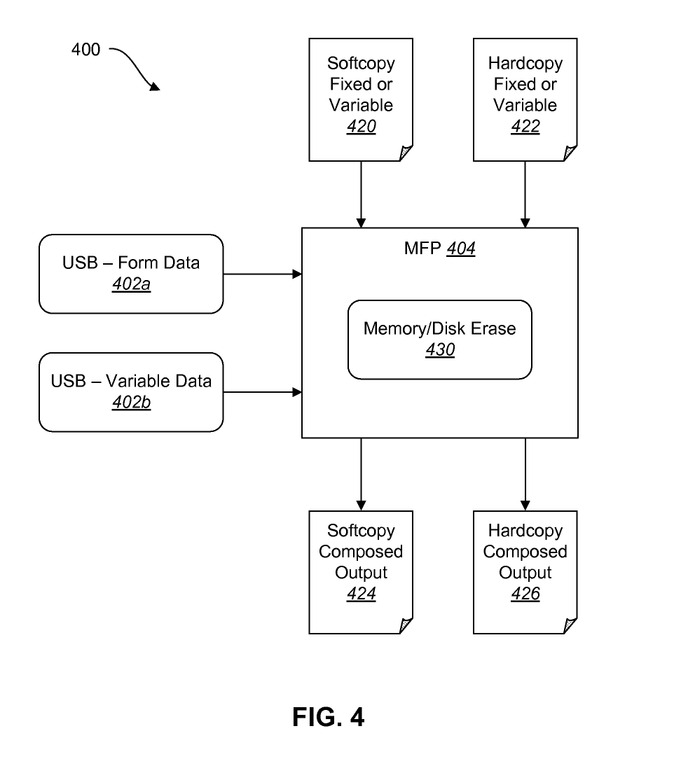

FIG. 4 is a block diagram illustrating another embodiment 400 for variable form printing using removable storage 402. In this system 400, the MFP 404 may take at least one of the fixed or variable portions of an output job from traditional hardcopy 422 (e.g., scanner) or softcopy 420 inputs (e.g., print). The MFP 404 may also take at least one of the fixed 402a or variable portions 402b of an output job from removable media 402 (e.g., USB memory stick), which is communicatively coupled to the MFP 404. The MFP 404 then renders, if not already, the combined fixed and variable portions of the output job into a composed rendered document 424 or 426. The composed rendered document is then outputted to any of the supported output engines (e.g., copier, fax, file, send to destination, etc.). The composed rendered document may be softcopy output 424 or hardcopy output 426.

When the MFP 404 accesses the fixed/variable data from the removable storage 402, it may need to make a temporary copy in either memory 430 and/or other storage 430. When completed, the MFP 404 may delete the copy from memory/storage 430, such that it is not accessible again.

Additionally, other services may be provided with the system 400. For example, authentication/access control to data on the removable media 402 may be provided. Decryption of data on the removable media 402 may also be provided, as well as rendering services (such as translation), and other services (such as language translation) by an external host.

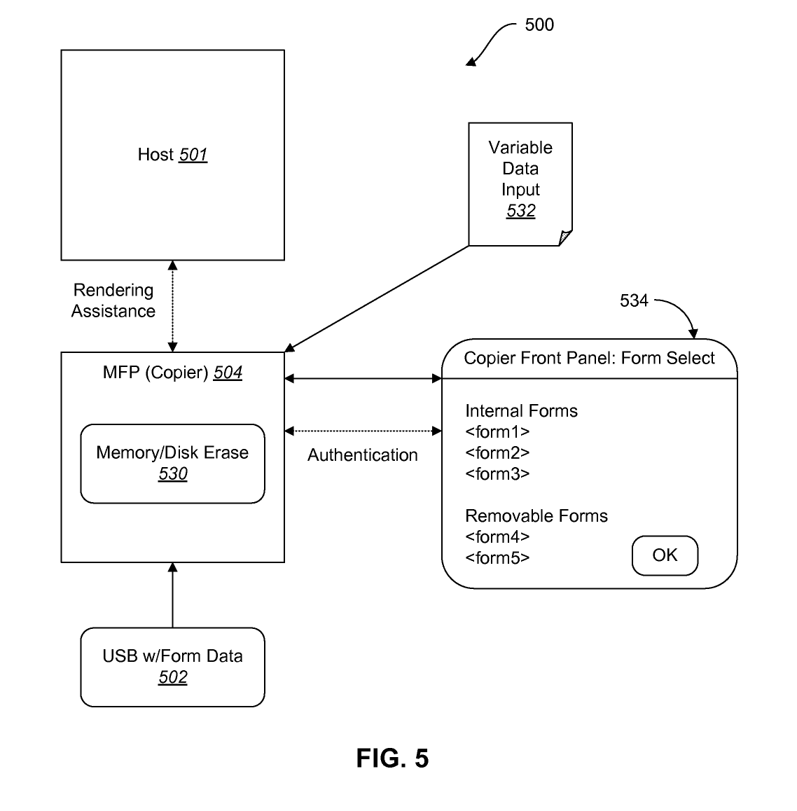

FIG. 5 is a block diagram illustrating an embodiment 500 for variable form printing using removable storage 502 where at least one fixed portion of the variable data printing job is on removable media 502, and at least one variable portion is from another source 532. In one mode of this embodiment 500, the user initiates an outputting job at the MFP 504 as a walkup copy job. The user inserts the removable media 502 into a port connection that is coupled to the MFP 504 within its immediate vicinity, such as a locally connected port, or a wireless connected port. In an alternate method, the removable media 502 may be inserted into a port connection which is remote from the MFP 504, but which is accessible to the MFP 504. In another embodiment, the removable media 502 may be further secured by connecting it to a port that is contained within a physically secured lock box.

The fixed portion on the removable media 502 may be, but is not limited to, form, layout, imposition rules, rendering settings, watermark/overlay, fonts, and other indicia. The outputting job may include multiple fixed parts, which may reside on the same removable media 502, on other removable media, locally stored on the MFP 504, remotely accessible from the MFP 504 (e.g., FTP), etc. The user may select the fixed portion(s) from the removable media 502 via the MFP 504 walkup user interface 534 (e.g., front panel). Typically, the MFP 504 has a driver for the removable media 502 that allows the MFP 504 to browse the contents, select file(s) and download data from one or more files. The MFP 504 may support any means for file selection from the removable media 502, such as manual browsing/selection of the media contents, predetermined selection, such as by file suffix, file name or file location, automated search/selection by specifying file name, file name pattern, file attributes, metadata or file contents, etc.

Additionally, the MFP 504 may support authentication/access control to the fixed portion on the removable media 502. For example, the files on the removable media 502 may be protected by any of the following: PIN control, user/password control, encryption, Discretionary Access Control (DAC) such as matching the authenticated user to the owner of the files being accessed. The information to access these files may be inputted by the user by any means, such as manual entry through a front panel user interface 534, at the keyboard, prior authentication when accessing/enabling the MFP 504, biometric, smartcard, Magcard, etc.

The fixed portion(s) on the removable media 502 may be in any form, such as rendered format ready for the output engine, printable format which can be interpreted by the MFP 504, or non-native format. In the later case, the MFP 504 may use external rendering service to translate the non-native format into a format native (printable or engine ready) to the MFP 504. Additionally, the external rendering service may provide other rendering services, such as RIP, load balancing, or half-toning.

The variable data portion 532 may come from any source, such as, but not limited to, the same removable media 502, different removable media, inputted at the MFP 504 (keyboard entry, scanned in, profile selection), inputted from a remote source (FTP access to data, database access to data). The variable data 532 may be in any format, such as those described for the fixed data. Finally, the MFP 504 completes the rendering, if any, of the fixed and variable portions, and merges the rendered portions into a composed rendered document. The composed rendered document is then passed to the output engine for outputting.

It is possible that the MFP 504, in some cases, may use rendering assistance from a host 501 that is in electronic communication with the MFP 504. The host 501 may provide rendering assistance as needed or as requested.

Once the MFP 504 has accessed the fixed data from the removable storage 502, the data is stored in memory 530 or other storage that is not accessible by other processes other than the requested outputting job. When the MFP 504 completes the outputting job, the MFP 504 then deletes the temporary copy and may additionally obscure any residual of the temporary copy, through various memory/disk erase methods. Examples of such erase methods are disclosed in U.S. Patent Application Publication No. 2005/0068578 for “Random Bit Mask By-Product File Disk Obscuring.”

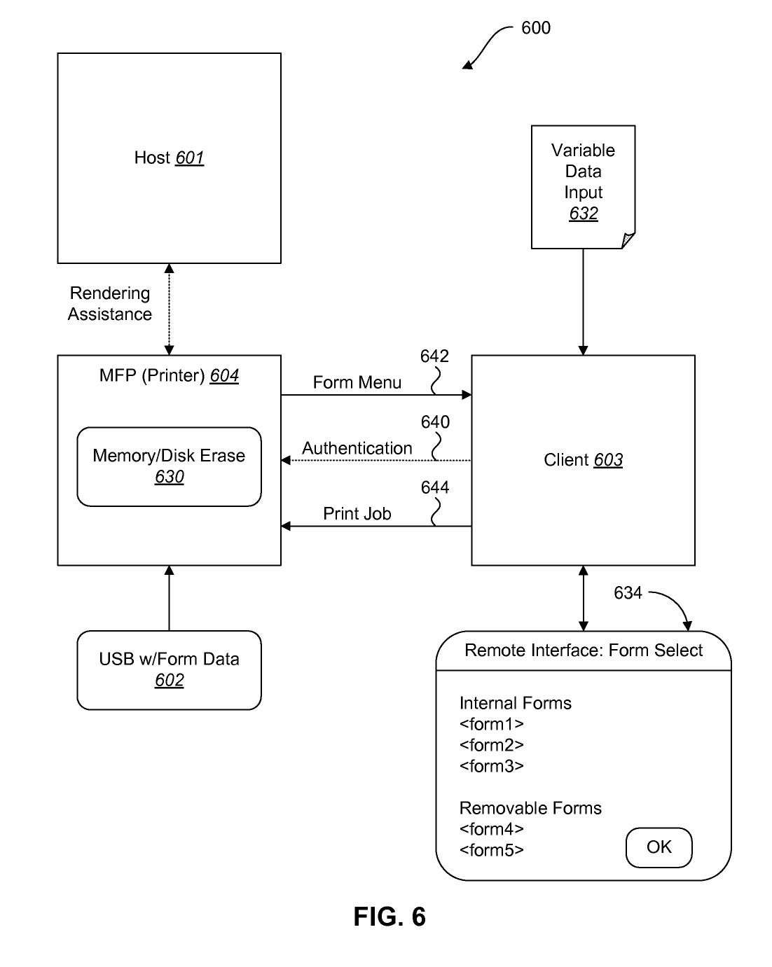

FIG. 6 is a block diagram illustrating another embodiment 600 for variable form printing using removable storage 602 where the user initiates the variable data printing job from a remote interface 634 (e.g., host), such as a print job. The remote interface 634 may be provided through various devices including, by way of example, through a client 603 or a host 601. In one embodiment, a menu 642 may be brought up on a client 603. At least one fixed portion of the print job is on removable media 602. The removable media 602 may be connected to the MFP 604. Alternatively, the removable media 602 may be connected to the host 601.

A process on the host 601 is communicatively coupled to the MFP 604. The process is able to query the MFP 604 for the purpose of browsing/selecting the at least one fixed part of the job from the removable storage 602. Any bidirectional communication means may be used, such as, but not limited to, FTP (File Transfer Protocol), HTTP (Hypertext Transfer Protocol), PJL (Printer Job Language) file system, SOAP (Simple Object Access Protocol) /XML (Extensible Markup Language), WS (Web Services), proprietary communication, such as over TCP/IP (Transmission Control Protocol/Internet Protocol).

The fixed portion on the removable media 602 may be of any form, such as those described earlier. The outputting job may also have multiple fixed parts, which may reside anywhere, such as those described earlier.

Additionally, the MFP 604 may support authentication/access control 640 to the fixed portion on the removable media 602, such as those described earlier. The information to access these files may be inputted by the user by any means, such as those described earlier.

The MFP 604 may use external rendering services to translate the non-native format into a format native (printable or engine ready) to the MFP 604. Additionally, the external rendering service may provide other rendering services, such as those described earlier.

The variable data portion 632 may come from any source, such as those described earlier. The variable data 632 may be in any format, such as those described for the fixed data. The host 601 or client 603 may process the variable data 632, and other portions, of the data into any format 644 which can be processed by the MFP 604, such as original document format, printable format, output engine format, etc.

Finally, the MFP 604 completes the rendering, if any, of the fixed 602 and variable 632 portions, and merges the rendered portions into a composed rendered document. The composed rendered document is then passed to the output engine for outputting.

Once the MFP 604 has accessed the fixed data from the removable storage 602, the data is stored in memory 630 or other storage that is not accessible by other processes, other than the requested outputting job. When the MFP 604 completes the outputting job, the MFP 604 then deletes the temporary copy and may additionally obscure any residual of the temporary copy, through various memory/disk erase methods.

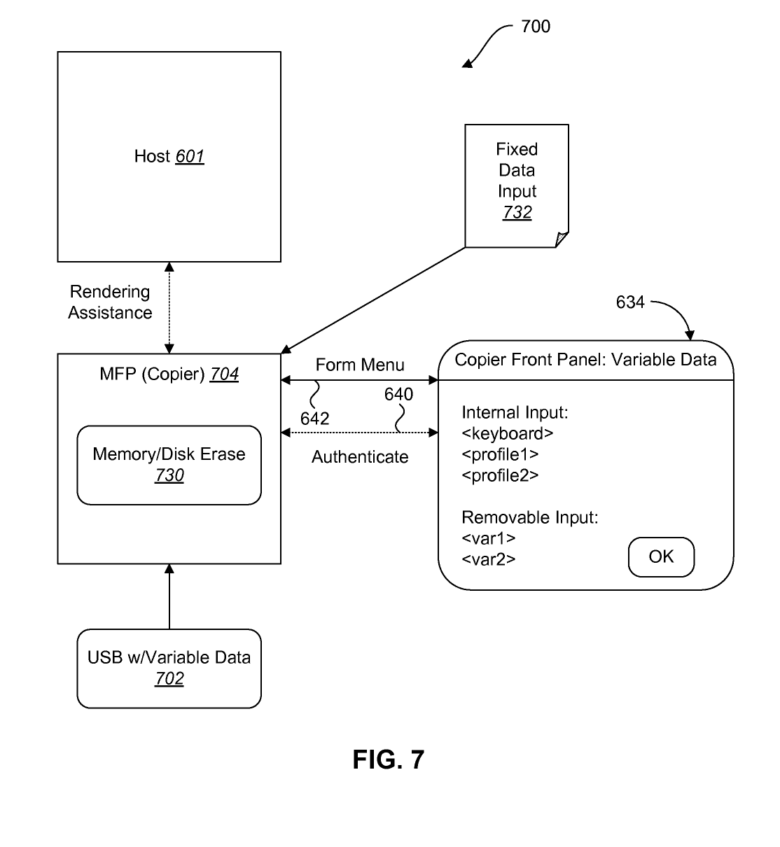

FIG. 7 is a block diagram illustrating another embodiment 700 for variable form printing using removable storage 702 where at least one variable portion of the variable data printing job is on removable media 702, and at least one fixed portion is from another source 732. The features and characteristics for this embodiment may be similar to previous embodiments, except that at least one variable portion of the data is selected from the removable media 702 instead of a fixed portion; and at least one portion of the fixed data is selected from another source 732, instead of a variable portion. In the embodiment 700 of FIG. 7, the systems and methods are shown in the context of a copy job.

Again, once the MFP 704 has accessed the variable data from the removable storage 702, the data is stored in memory 730 or other storage that is not accessible by other processes, other than the requested outputting job. When the MFP 704 completes the outputting job, the MFP 704 then deletes the temporary copy and may additionally obscure any residual of the temporary copy, through various memory/disk erase methods.

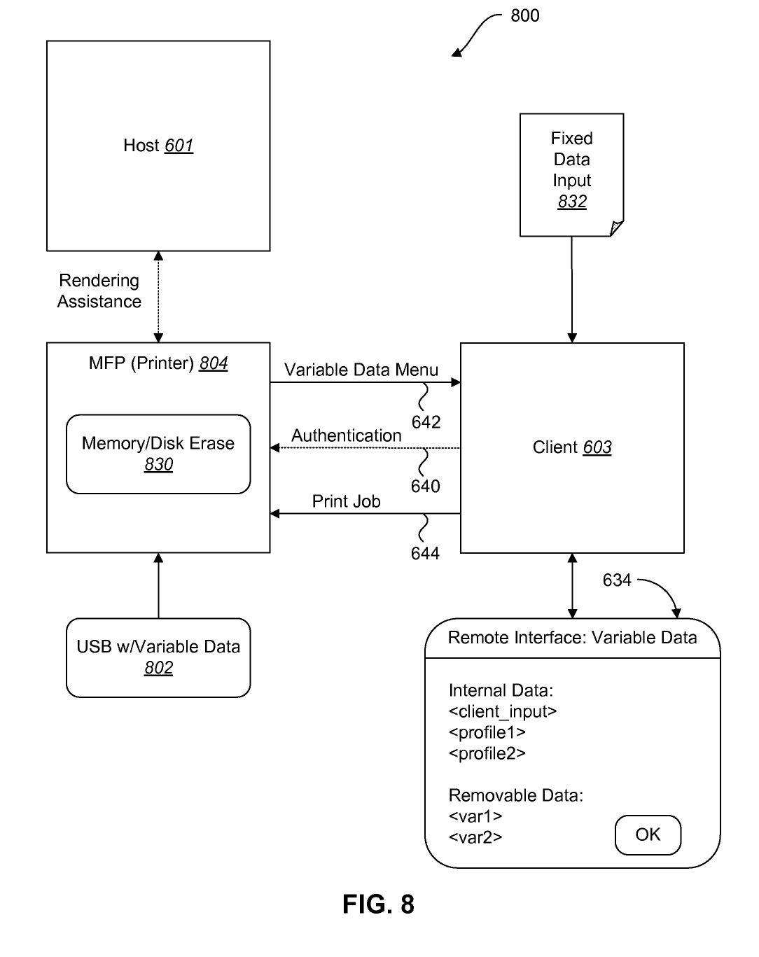

FIG. 8 is a block diagram illustrating another embodiment 800 for variable form printing using removable storage 802 where at least one variable portion of the variable data printing job is on removable media 802, and at least one fixed portion is from another source 832. The features and characteristics for this embodiment may be similar to previous embodiments, except that at least one variable portion of the data is selected from the removable media 802 instead of a fixed portion; and at least one portion of the fixed data is selected from another source 832, instead of a variable portion. In the embodiment 800 of FIG. 8, the systems and methods are shown in the context of a print job.

Again, once the MFP 804 has accessed the variable data from the removable storage 802, the data is stored in memory 830 or other storage that is not accessible by other processes, other than the requested outputting job. When the MFP 804 completes the outputting job, the MFP 804 then deletes the temporary copy and may additionally obscure any residual of the temporary copy, through various memory/disk erase methods.

While the embodiments discussed files stored on a USB memory stick, any type of removable storage may be used, such as floppy, CD, DVD, removable hard-drive, wireless transfer to mobile device (laptop, cell phone, etc). Additionally, the fixed and/or variable portions may be stored on the MFP, host or removable media for reuse. The portion(s) may be stored in any format: original, printable or engine ready. Additionally, once a fixed or variable portion is rendered, the rendered version may be stored back on the removable media for reuse.

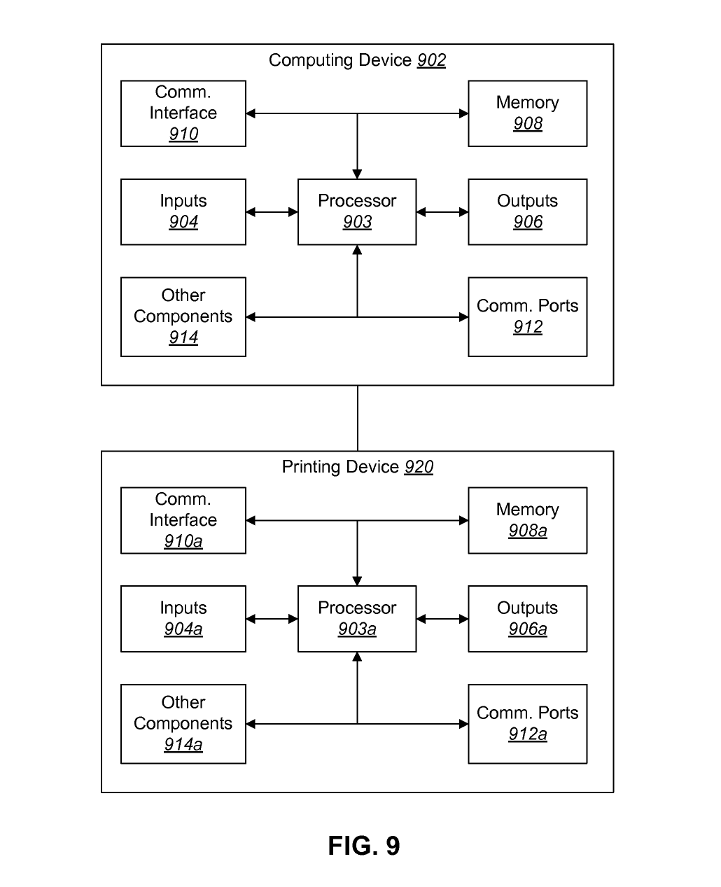

FIG. 9 is a block diagram illustrating the major hardware components typically utilized with embodiments herein. The systems and methods disclosed may be used with a computing device 902 and a printing device 920, imaging device or MFP. The major hardware components typically utilized in a computing device 902 are illustrated in FIG. 9. A computing device 902 typically includes a processor 903 in electronic communication with input components or devices 904 and/or output components or devices 906. The processor 903 is operably connected to input 904 and/or output devices 906 capable of electronic communication with the processor 903, or, in other words, to devices capable of input and/or output in the form of an electrical signal. Embodiments of devices 902 may include the inputs 904, outputs 906 and the processor 903 within the same physical structure or in separate housings or structures.

The computing device 902 may also include memory 908. The memory 908 may be a separate component from the processor 903, or it may be on-board memory 908 included in the same part as the processor 903. For example, microcontrollers often include a certain amount of on-board memory.

The processor 903 is also in electronic communication with a communication interface 910. The communication interface 910 may be used for communications with other devices 902, printing devices 920, servers, etc. Thus, the communication interfaces 910 of the various devices 902 may be designed to communicate with each other to send signals or messages between the computing devices 902.

The computing device 902 may also include other communication ports 912. In addition, other components 914 may also be included in the computing device 902.

Many kinds of different devices may be used with embodiments herein. The computing device 902 may be a one-chip computer, such as a microcontroller, a one-board type of computer, such as a controller, a typical desktop computer, such as an IBM-PC compatible, a Personal Digital Assistant (PDA), a Unix-based workstation, etc. Accordingly, the block diagram of FIG. 9 is only meant to illustrate typical components of a computing device 902 and is not meant to limit the scope of embodiments disclosed herein.

The computing device 902 is in electronic communication with the printing device 920, imaging device or MFP. A printing device 920 is a device that receives or transmits an imaging job, such as a Multi-Function Peripheral (“MFP”) or computing device. Printing devices include, but are not limited to, physical printers, multi-functional peripherals, a printer pool, a printer cluster, a fax machine, a plotter, a scanner, a copier, a logical device, a computer monitor, a file, an electronic whiteboard, a document server, etc. A typical printing device, such as a physical printer, fax machine, scanner, multi-functional peripheral or copier is a type of computing device. As a result, it also includes a processor, memory, communications interface, etc., as shown and illustrated in relation to FIG. 9. The printing device may be a single or a plural grouping (e.g., pool or cluster) of two or more devices.

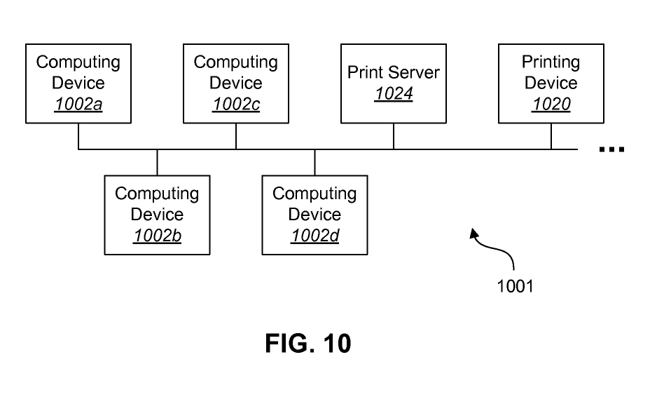

FIG. 10 is a network block diagram illustrating one possible environment in which the present systems and methods may be implemented. The present systems and methods may also be implemented on a standalone computer system. FIG. 10 illustrates a computer network 1001 comprising a plurality of computing devices 1002, a printing device 1020 and a print server 1024. The network 1001 may include a local-area network (LAN), a wide-area network (WAN), a campus-area network (CAN), a metropolitan-area network (MAN), a home-area network (HAN), a client/server network, a peer-to-peer network, an application-server network, the Internet, a paging network, a wireless network, a token ring network, an Ethernet network, etc.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A method for printing using removable storage, the method comprising:
initiating an imaging job, wherein the imaging job comprises a fixed portion and a variable portion;
providing the fixed portion to an imaging device;
providing the variable portion to the imaging device, and wherein one of the fixed portion or the variable portion is communicated from a removable storage device to the imaging device;
merging the fixed portion and the variable portion into a combined document; and
outputting the combined document.

2. The method of claim 1, further comprising clearing data from memory of the imaging device.

3. The method of claim 1, wherein the imaging device is a multi-functional peripheral (MFP).

4. The method of claim 1, further comprising performing authentication in order to access one of the fixed portion or the variable portion.

5. The method of claim 1, wherein the removable storage device comprises a Universal Serial Bus (USB) memory stick.

6. The method of claim 1, wherein the outputting comprises providing the combined document to an output engine selected from the group consisting of a copier, a fax, a file, and a send to destination.

7. The method of claim 1, further comprising inserting the removable storage device into a local port connection on the imaging device.

8. The method of claim 1, wherein the fixed portion comprises fixed data selected from the group consisting of form, layout, imposition rules, rendering settings, watermark, fonts, and overlay.

9. The method of claim 1, further comprising providing an interface for selection of the fixed portion or the variable portion.

10. An imaging device that is configured for printing using removable storage, the imaging device comprising:
a processor;
memory in electronic communication with the processor;
instructions stored in the memory, the instructions being executable to:
receive an initiation for an imaging job, wherein the imaging job comprises a fixed portion and a variable portion;
access the fixed portion by the imaging device;
access the variable portion by the imaging device, and wherein one of the fixed portion or the variable portion is communicated from a removable storage device to the imaging device;
merge the fixed portion and the variable portion into a combined document; and
output the combined document.

11. The imaging device of claim 10, wherein the imaging device is a multi-functional peripheral (MFP).

12. The imaging device of claim 10, wherein the instructions are further executable to clear data from the memory of the imaging device.

13. The imaging device of claim 10, further comprising a Universal Serial Bus (USB) port.

14. The imaging device of claim 13, wherein the removable storage device is accessed through the USB port.

15. The imaging device of claim 10, wherein the outputting instructions provide the combined document to an output engine selected from the group consisting of a copier, a fax, a file, and a send to destination.

16. The imaging device of claim 10, wherein the fixed portion comprises fixed data selected from the group consisting of form, layout, imposition rules, rendering settings, watermark, fonts, and overlay.

17. The imaging device of claim 10, wherein the instructions are further executable to provide an interface for selection of the fixed portion or the variable portion.

18. A computer-readable medium comprising executable instructions for printing using removable storage, the instructions being executable to:
initiate an imaging job, wherein the imaging job comprises a fixed portion and a variable portion;
provide the fixed portion to an imaging device;
provide the variable portion to the imaging device, and wherein one of the fixed portion or the variable portion is communicated from a removable storage device to the imaging device;
merge the fixed portion and the variable portion into a combined document; and
output the combined document.
